(19) United States
(12) Patent Application Publication
(10) Pub. No.: US 2019/0347281 A1
(43) Pub. Date: Nov. 14, 2019

(54) APPARATUS AND METHOD FOR SEMANTIC SEARCH

(71) Applicant: Dennemeyer Octimine GmbH, Munchen (DE)

(72) Inventor: Michael Natterer, Munchen (DE)

(21) Appl. No.: 16/348,825

(22) PCT Filed: Nov. 8, 2017
(86) PCT No.: PCT/EP2017/078674

§ 371 Date: May 9, 2019

(30) Foreign Application Priority Data
Nov. 11, 2016 (EP) 16198539.5

(51) Int. Cl. G06F 16/33; G06F 17/27; G06K 9/62

(52) U.S. Cl. CPC G06F 16/3347; G06F 16/3344; G06F 16/3335; G06K 9/6215; G06F 17/2785

(57) ABSTRACT

Disclosed is a computer-implemented method for comparing text documents. The method comprises building a database comprising first text document data associated with a plurality of first text documents. The method further comprises receiving a query. The method also comprises converting the query to second text document data. The method further comprises comparing second text document data to first text document data and computing at least one similarity measure between second text document data and first document data. Further disclosed is a computer-implemented method for processing of similarities in text documents. The method comprises harmonizing at least one incoming query. It further comprises normalizing the at least one incoming harmonized query. The method also comprises constructing at least one query vector using the at least one normalized harmonized query. The method further comprises computing at least one similarity measure between the at least one query vector and at least one further text document, wherein the at least one further text document underwent the previous steps. Also disclosed is a computer-implemented system. The system comprises at least one memory component adapted for at least storing a database comprising a plurality of first text document data associated with first text documents. The system also comprises at least one input device adapted for receiving a query. The query comprises a second text document and/or information identifying a second text document. The second text document is associated with second text document data comprised within first text document data already stored within the memory component. The system further comprises at least one processing component adapted for converting a query into second text document data and/or retrieving second text document data associated with the query from storage within the at least one memory component. The processing component is also adapted to compare second text document data to the first text document data stored within the at least one memory component. The system also comprises at least one output device adapted for returning information identifying at least one similar first text document associated with first text document data. The similar first text documents is most similar among first text documents to the query.

### FIELD

The invention relates to the field of data analysis and transformation. In particular, the invention relates to semantic search. More precisely, the invention describes a search engine adapted to semantically compare text documents.

### INTRODUCTION

Searching for similar documents among archives or databases containing enormous amounts of data has been one of the most difficult problems to solve since the appearance of such archives, in particular on the internet. One of the solutions to this problem is a brute-force approach searching for exact user-defined keywords in all of the available documents. This approach is efficient in terms of processing power, but presents some limitations: depending on the topic at hand, the same keyword may mean vastly different things, and the use of synonyms or similar expressions means that a search might have to be repeated multiple times to get all of the relevant hits.

In a more specific example concerning prior art search, searching for similar patents is often done through the IPC (International Patent Classification) classes, through the CPC (Cooperative Patent Classification) classes, or through citations listed by each patent. This approach may yield some relevant hits, but is likely to miss similar documents that are more recent (and have not been cited yet), or give too many hits that are only tangentially related (in the case of searching by IPC or CPC classes).

A more well-rounded approach to combing documents for similarity can be done by a semantic search. This sort of search would take into consideration synonyms, expressions consisting of more than one word, technical terms specific to a certain field and combine all of them for a more precise similarity comparison. This type of search can be done using a multidimensional vector space where different terms or texts would be defined as vectors, and similarity comparisons are performed directly on this vector space.

U.S. Pat. No. 8,688,720 discloses a system characterizing a document with respect to clusters of conceptually related words. Upon receiving a document containing a set of words, the system selects “candidate clusters” of conceptually related words that are related to the set of words. These candidate clusters are selected using a model that explains how sets of words are generated from clusters of conceptually related words. Next, the system constructs a set of components to characterize the document, wherein the set of components includes components for candidate clusters. Each component in the set of components indicates a degree to which a corresponding candidate cluster is related to the set of words.

U.S. Pat. No. 8,935,230 discloses a method, machine readable storage medium, and system for providing a self-learning semantic search engine. A semantic network may be set up with initial configuration. A search engine coupled to the semantic network may build indexes and semantic indexes. A user request for business data may be received. The search engine may be accessed via a semantic dispatcher. And based on the access, search engine may update the indexes and semantic indexes.

US patent application 2014/280088 describes a system and related method for searching a data set made up of a set of documents, a set of terms, and a vector associated with each term and each document. The method involves converting a search query to a vector in the vector space spanned by the term and document vectors, and combining vector-proximity searching and term searching to produce a set of results, which may be ranked according to various measures of relatedness to the query.

### SUMMARY

The present invention is specified in the claims as well as in the below description. Preferred embodiments are particularly specified in the dependent claims and the description of various embodiments.

The above features along with additional details of the invention, are described further in the examples below, which are intended to further illustrate the invention but are not intended to limit its scope in any way.

In light of known prior art, it is therefore the object of this invention to disclose a method and an apparatus for performing semantic search with at least some of the following features:
1) Implementing different ways to perform specialized and in particular trained to technical language part-of-speech tagging, clean up text, remove stop words, reduce words to stems and phrases, correct for spelling errors, harmonize language styles, correct for synonyms, clean OCR (optical character recognition) errors, perform a multi-component weighting and use different similarity indices;
2) Integrating analyses of lexical and semantical algorithms and assumptions;
3) Simultaneously considering and implementing different text-related information and different algorithms;
4) Analysing texts across all technological fields;
5) Implementing the connection between text similarity measures and bibliographic characteristics;
6) Integrating text-based and bibliographic methods of similarity determination.

In the present document, the words “keyword”, “term” and “semantic unit” can be used interchangeably. Furthermore, the words “keyword” or “term” can refer to an expression and not to a single word.

In a first embodiment, the invention discloses a computer-implemented method for comparing text documents. The method comprises building a database comprising first text document data associated with a plurality of first text documents. The method further comprises receiving a query. The method also comprises converting the query to second text document data. The method further comprises comparing second text document data to first text document data and computing at least one similarity measure between second text document data and first document data. Such a similarity measure can for example comprise a similarity index. This can advantageously present a quantifiable way of comparing text documents to each other.

Note, that the query can comprise a second text document, in which case this second text document can be converted to second text document data. However, the query can also simply identify a second text document that is already contained within the database as part of first text document data. In this case, the second text document data already exists, and should simply be retrieved from the database and compared to the other data comprised in the database.

The present method allows for efficient and reliable way of converting text documents to data that can be analysed and quantifiably compared to other data. The conversion and comparison can preferably be performed by a computing device, in a preferably parallelized way. The described method can be implemented on a server accessible with a user interface. It can serve to allow users to identify similar text documents for a variety of uses.

In some preferred embodiments, first text document data comprises document vectors generated from keywords comprised in first text documents and/or words semantically related to said keywords. That is, each first text document can be associated with a document vector stored within the database.

The database may or may not comprise first text documents themselves. It can be advantageous to store only document vectors associated with first text documents to save storage space within the database. Conversely, it can be advantageous to store first text documents as well, for easy and quick retrieval as a response to the query for example.

Words semantically related to said keywords can comprise for example synonyms, hypernyms and/or hyponyms. To correctly identify semantically related words, external databases can be used. These can be generic and/or subject-specific.

In some embodiments, the query can comprise a second text document. Additionally or alternatively, the query can comprise information identifying a second text document associated with second text document data already stored within the memory component. In the second case, second text document data associated with said second text document can simply be retrieved from the database and then compared to remaining first text document data within the database. Note, that in this case, second text document data can be comprised within first text document data and is referred to in a different way to avoid confusion.

In some embodiments, converting the query to second text document data can comprise harmonizing the query. In some preferred embodiments, harmonizing can comprise correcting typographical errors, choosing a particular spelling convention and physical unit convention and adjusting the text based on it, and/or representing formulas (for example chemical formulas, gene sequences and/or protein representations) in a standard way. This can advantageously allow for more reliable comparison between text documents relating to the same subject, but using different conventions or different units.

In some embodiments, converting the query to second text document data can comprise normalizing the query. In some preferred embodiments, normalizing comprises identifying and removing stop words, reducing words to common word stems, analysing the stems for synonyms and/or identifying word sequences and compound words.

In some embodiments, normalizing the query can comprise retrieving at least synonyms, hypernyms, hyponyms, stop words and/or subject specific stop words from an external database and generating a list of the query's keywords based at least partially based on said retrieved words. There can be one or a plurality of external databases separated by the topic. This can be advantageous, as words can comprise different meanings depending on the subject. For example, an expression such as “delivery system” can have entirely different meanings depending on whether it is used in the context of logistics or medicine.

Therefore, the corresponding synonyms, hypernyms, hyponyms and/or other semantically related words can also be different depending on the technical area in question. As another example, consider an embodiment where the invention is used as part of a semantic search tool, particularly for prior art in the context of patent literature. Patent applications and grants have very specific words that can be repeated in documents on entirely different subjects. Words such as “claim”, “comprising”, “device”, “embodiment” can be considered as patent literature-specific stop words and can be removed from the query. In embodiments where the database comprises patent literature, said specific stop words can also be removed from all of the first text documents in the process of converting them to first text document data (that is, in the process of building or creating the database). In some embodiments, the list of the query's keywords can be generated by removing stop words and/or subject-specific stop words and including at least one of the synonyms, hypernyms and hyponyms of the query's words.

In some embodiments, converting the query to second text document data can comprise generating at least one query vector. The query vector can, for example, comprise information about the query's keywords. That is, the components of the query vector can correspond to the keywords of the query and/or their semantically related words such as synonyms. Note, that in the present document, “keywords” can refer both to actual words comprised within the query and/or to their semantically related words such as synonyms, hypernyms and/or hyponyms. In some such embodiments, the query vector can be generated by identifying keywords and/or synonyms of keywords from the query and identifying said keywords with components of a vector in a multidimensional vector space. In some embodiments, the query vector can comprise from 100 to 500 components, preferably from 200 to 400 components, even more preferably from 200 to 300 components. That is, in some such embodiments, not every keyword and associated semantically related words are associated with a component of the query vector. This can mean, for example, that the keywords are first evaluated and weighted based on different parameters, and then the keywords with a low weight discarded. This can be particularly advantageous, as lowering the number of keywords contributing to the query vector can significantly reduce the necessary computing power necessary to manipulate the query vector, such as when comparing it to document vectors. Note, that document vectors can similarly comprise from 100to 500 components, preferably from 200to 400 components, even more preferably from 200to 300 components. First document data comprised in the database and associated with first text documents, which, in some embodiments comprises document vectors, can be generated similarly to the query vector—by identifying keywords or semantic units and reducing their number to a hundred or a few hundred per first text document based on the entropy associated with them.

In some preferred embodiments, the keywords can be assigned a weight. In such embodiments, weights can be assigned at least partially based on the general subject of the query. That is, the same term, keyword and/or semantic unit can be assigned a different weight depending on the context, or on the subject of the text document. That is, for example, the term “frequency” can be weighted differently depending on whether the query is in the subject of telecommunication, where it likely refers to electromagnetic wave frequency or in the subject of medicine, where it likely refers to how often something occurs. In embodiments where first text document data comprises document vectors, the same can apply to the document vectors associated with first text documents. That is, the keywords, terms and/or semantic units comprised within first text documents or semantically related to words comprised within them can be assigned a different weight based on the subject. This is particularly advantageous, as it allows to make more meaningful comparisons between first text documents and the query. Note, that determining which technical area a particular text document belongs to can be done in several ways. If the document in question comprises patent literature, its classification can be used. That is, IPC and/or CPC classes of a given document can be used to assign it to a certain technological area. Another way can be identifying certain subject or area-specific terms, keywords and/or semantic units that are particularly prevalent in certain areas (external databased can also be used for this purpose), and then assigning text documents to technical areas based on the presence of these subject-specific terms.

In some embodiments, computing the similarity measure comprises applying at least one or a combination of the Cosine Index, Jaccard Index, Dice Index, Inclusion Index, Person Correlation Coefficient, Levenstein Distance, Jaro-Winkler Distance and/or Needleman-Wunsch Algorithm. That is, particularly in embodiments where first text document data comprises document vectors and second text document data comprises a query vector, comparing the two can be done by computing the distance between them in a multidimensional vector space. This can be done using several different distance definitions. Note, that different distance definitions can be used for different purposes.

In some preferred embodiments, the method for comparing text documents further comprises validating the at least one similarity measure using at least one statistical algorithm. The method can further comprise outputting the at least one similarity measure. That is, consider again the example of comparing patent literature. Patent applications and/or grants usually comprise references to other similar documents. These references are often either cited in the document itself, or later provided by the examiner. The references are used as prior art, which can mean that they are very similar to the document. In this way, a similarity measure between the query and a certain first text document can be tested by verifying the similarity measure between the query and the references given in this particular first text document. If the similarity measure is reliable, one can expect that this verification will yield similar similarity measures between the query and the references.

In some embodiments, the query can be received from a user interface and the similarity measure can be returned via said interface. Such an interface can comprise an app, a program and/or a browser-based interface. That is, the method can be implemented as part of a program allowing a user to quantitatively and reliably compare the similarity of various text documents.

In some embodiments, the database comprises patent literature-related text documents and building the database and/or converting the query comprises removing stop words associated with patent literature-related text documents. As mentioned above, such patent literature-specific stop words can comprise words like “claim”, “device”, “embodiment”, “comprise” and similar. In some embodiments, patent-related stop words can be removed by computing the entropy associated with terms comprised in first text document data and/or in the query and removing terms with low entropy. This is further discussed below.

In some preferred embodiments, the method can further comprise generating a term vector comprising keywords extracted from the plurality of first text documents. That is, the term vector can be generated based on first text document data comprised within the database and associated with first text documents. The term vector can be generated based on all of the keywords, terms and/or semantic units comprised within all of the first text documents. In such embodiments and in embodiments where the first text document data can comprise document vectors and second text document data can comprise the query vector, the components of the document vectors and the query vector can be generated with respect to the components of the term vector. That is, the term vector can provide the underlying common ground to compare the query and the first text documents. Put differently, the term vector can define the multidimensional vector space with respect to which the comparison can be done. This is particularly advantageous, as it allows for quantitative mathematical comparison between different text documents.

In some embodiments, the similarity measure between second text document data and first document data can be computed by using the cosine index to compute the distance between the query vector and the document vectors. As mentioned above, the cosine index can be used to compute distances in a multidimensional vector space. It can be particularly advantageous, as it can be reduced to an inner product of two vectors. This can significantly reduce the computing time of the comparison, as such an operation can be easy to implement.

In a second embodiment, the invention discloses a computer-implemented method for processing of similarities in text documents. The method comprises harmonizing at least one incoming query. It further comprises normalizing the at least one incoming harmonized query. The method also comprises constructing at least one query vector using the at least one normalized harmonized query. The method further comprises computing at least one similarity measure between the at least one query vector and at least one further text document, wherein the at least one further text document underwent the previous steps.

Note, that the further text document can also be referred to as a first text document. Undergoing the previous steps can refer to the further or first text document having been harmonized, normalized, and having a document vector constructed.

The present method advantageously allows for converting an arbitrary query comprised of text into data that can be quantitatively compared with other data in order to evaluate the similarity of the query to other data. This is preferably performed by a computing device which has data associated with various text documents stored in its memory and can retrieve it to compare with an incoming query. The text of the query can then be analysed using various techniques and algorithms implemented by a computing device.

In some preferred embodiments, the text document can comprise at least one or a combination of technical text, scientific text, patent text, and/or product description.

In some embodiments, harmonizing can comprise correcting typographical errors, choosing a particular spelling convention and physical unit convention and adjusting the text based on it, and/or representing formulas (for example chemical formulas, gene sequences and/or protein representations) in a standard way.

In some embodiments, normalizing can comprise identifying and removing stop words, reducing words to common word stems, analysing the stems for synonyms and/or identifying word sequences and compound words. In such embodiments, normalizing can further comprise identifying and removing stop words associated with a certain type of text documents, preferably by computing the entropy of terms within a plurality of text documents of said type and removing words with low entropy.

In some embodiments, computing the similarity measure can comprise applying at least one or a combination of the Cosine Index, Jaccard Index, Dice Index, Inclusion Index, Person Correlation Coefficient, Levenstein Distance, Jaro-Winkler Distance and/or Needleman-Wunsch Algorithm. Such algorithms allow for a quantitative comparison between text documents based on the distance of data generated from the text documents in a multidimensional vector space.

In some embodiments, the method can further comprise validating the at least one similarity measure using at least one statistical algorithm. It can further comprise outputting the at least one similarity measure.

Note, that the first and second embodiments can be complementary. That is, embodiments presented as being part of the first embodiment can be part of the second embodiment and vice versa.

In a third embodiment, the invention discloses a computer-implemented system. The system comprises at least one memory component adapted for at least storing a database comprising a plurality of first text document data associated with first text documents. The system also comprises at least one input device adapted for receiving a query. The query comprises a second text document and/or information identifying a second text document. The second text document is associated with second text document data comprised within first text document data already stored within the memory component. The system further comprises at least one processing component adapted for converting a query into second text document data and/or retrieving second text document data associated with the query from storage within the at least one memory component. The processing component is also adapted to compare second text document data to the first text document data stored within the at least one memory component. The system also comprises at least one output device adapted for returning information identifying at least one similar first text document associated with first text document data. The similar first text document is most similar among first text documents to the query.

Note, that the query can preferably comprise one of two forms. In the first form, the query can comprise a second text document, in which case this second text document can then be appropriately transformed and associated to second text document data. In the second form, the query can comprise a reference to a second text document that is already contained within the database. For example, if the database comprises patent literature, the query can comprise a patent application number, or a grant number that can identify a particular second text document. This can be what is referred to as “information identifying a second text document”. Second text document data can then comprise, in the first case, data associated with the second text document that the query comprised. In the second case, second text document data can be retrieved from the database, based on the identifying information of the query. In the second case, second text document data can be comprised in the first text document data.

In other words, the system described herein is configured to receive, via an input device, an input of an arbitrary text-based query, verify whether the query can be associated with text document data stored in the memory, retrieve this data if so and convert the query into such data if not. The system is further configured to compare the query with other documents stored in the memory. The comparison can be done by the processing component via an implementation of different algorithms. The system can also output, via an output device, the result of the comparison in the form of text documents most closely associated with the query. The comparison itself can be done on the level of converted data (as outlined above and below, this data can comprise points in a multidimensional vector space), while the input and output can comprise actual text documents or their identifiers (such as a title of a paper, a patent number, and so on).

In some embodiments, the first text document data can comprise a plurality of document vectors and the second text document data can comprise a query vector. Note, that referring again to the two forms that the query can take, the query vector can either be generated from the text of the second text document that the query comprises, or retrieved from the database. In the second case, the query vector can be one of the document vectors, as it has already been stored in the database. For clarity and consistency, the term “query vector” is used herein for both of the cases. In preferred embodiments, each of the first text documents can be associated to a document vector that can be stored within the database. The database can store both the first text documents and the corresponding document vectors, or, just the document vectors.

In some embodiments, the memory component can comprise first text document data associated with scientific articles and/or technological descriptions and/or patent literature and or product description. Put differently, first text documents can comprise patent literature, scientific articles, and/or technological descriptions. Preferably, the database can comprise at least patent literature-related first text document data.

In some embodiments, second text document data can be obtained by harmonizing and normalizing the second text document and constructing at least one query vector. Harmonizing and normalizing is described in more detail above and below.

In some embodiments, the comparison between first text document data and second text document data can yield a similarity index. In some such embodiments, the output device can return information associated with a plurality of first text documents ordered by the similarity index from most similar to least similar, said first text documents associated with first text document data yielding the highest similarity index with second text document data. That is, the system can be adapted to output a list comprising a certain number of first text documents most similar to the query. In cases where first text documents comprise patent literature, this can be particularly advantageous as a method to perform prior art searches. Note, that the outputted first text documents can be stored in the database, and/or be output as information identifying them (such as a patent application or grant number), and/or be output as links to external databases where the documents can be accessed. Furthermore, it can be also advantageous to output some parts of the most similar first text documents. For example, the title and/or the abstract and/or one of the figures can be output.

In some embodiments, the similarity index can be based on lexical and/or semantic comparison between text documents. That is, the similarity index can quantitatively indicate similarities between the texts. This can, for example, refer to the quantity of keywords and/or semantic units that are present in the query and in the first text documents. Note, that obtaining the similarity index can be done by, for example, computing the distance between vectors in a vector space. However, the vectors themselves can be obtained based on lexical and/or semantic parameters. Therefore, the similarity index can be considered to be based on those parameters as well.

In some embodiments, the processing component can identify keywords during harmonizing and normalizing of the incoming second text document. Keywords can comprise words that are significantly relevant to the content of the text document. Keywords can comprise stems of words (obtained as part of normalizing), composite words, and/or a string of words semantically connected. Keywords can also comprise words that are not actually in the text document, but are synonyms or other semantically-linked words to the words contained in the text document.

In some embodiments, the processing component can assign weight to keywords based on an entropy algorithm. That is, some keywords can be ranked higher due to how often they occur in the document and/or how relevant they are considered within a specific technical area. The weight assigned to keywords can then be used when comparing first text document data and second text document data. That is, keywords with higher weight can contribute more to the similarity between documents and/or to the similarity index than keywords with lower weight. This can be particularly advantageous, as determining similarity between texts can be more accurate when the frequency and the specific meaning of words within the context is taken into account. This can result in a more robust comparison measure.

In some embodiments, the processing component can be adapted to divide the second text document into at least two parts for parallelized computing, preferably into at least four parts. This is advantageous, as it allows for an increased speed of processing, and therefore higher efficiency.

In some embodiments, the processing component can comprise at least two, preferably at least four, more preferably at least eight kernels. This can further increase the speed with which a query can be processed.

In some embodiments, the processing component can be adapted to update first document data stored within the memory component regularly. That is, the database can be updated with new first text documents.

In some embodiments, the input device can be further adapted to permit specifying the query by listing words and/or sentences that similar text documents must comprise and/or must not comprise. Put differently, consider again the example of a prior art search. It can be particularly useful to be able to specify words or expressions that must necessarily be comprised within text documents similar to the query. Additionally or alternatively, it can be very useful to specify words that must not be contained within the similar text documents.

In some embodiments, the input device can be further adapted to permit specifying the query by specifying the number of most similar text documents to be outputted.

In some embodiments, the memory component can comprise RAM (random-access memory). This is further discussed in relation to FIG. 1.

In some embodiments, the memory component can further comprise a term vector comprising keywords extracted from the plurality of first text documents. The term vector is described above in relation to the first embodiment. In some such embodiments, the processing component can be adapted to generate the components of the document vectors and the query vector with respect to the components of the term vector. In some such embodiments, where first text document data comprises document vectors and second text document data comprises a query vector, the processing component can be adapted to compare the second text document data to the first text document data by using the cosine index to compute the distance between the query vector and the document vectors.

Below follows a more formal discussion of one embodiment of the invention. Particularly, the concept of entropy as can be used within the context of the invention is clarified, and one way of quantifying similarities between different texts is given.

The entropy E(t) can be used to eliminate patent literature-specific stop words. That is, words such as “claim”, “means”, “invention”, “comprising” or other similar words. The following expression can be used:

$$E ( t ) = 1 + \frac{1}{log ( n )} {\sum }_{i = 1}^{n} \frac{{f}_{it}}{{\sum }_{j = 1}^{n} {f}_{jt}} log ( \frac{{f}_{it}}{{\sum }_{j = 1}^{n} {f}_{jt}} )$$

In the above expression, n refers to the total number of patents and/or documents, i and j are indices referring to patents and/or documents, fᵢₜ represents the frequency of term t in patent and/or document i, and the sum over fⱼₜ refers to the frequency of term t in all the patents and/or documents. The value of E(t) falls between zero and one. The terms that are distributed between the documents very specifically and unevenly can be weighted with a high entropy value. The higher the entropy value, the more information can the term carry. The patent specific stop word lists can be computed separately for abstract, claims, title, description and all of their combinations. The differentiation is important, as the claims of a patent are formulated very differently from, for example, the description.

After identifying the keywords by removing various stop words and by stemming them, the keywords can be implemented into a vector space model. The documents can then be represented as objects in a multi-dimensional space. The dimensions can be characterised by keywords or terms. In this way, each document can be described as a point and/or a vector in a multi-dimensional space. The value of each component of this point can represent the number of times a specific keywords or term is encountered in this document. A term vector T can be created in such a way that it contains all of the terms or keywords of all the considered documents exactly once:

T=(t₁, t₂, . . . , tₘ).

That is, a total of m terms or keywords can be contained in all the considered first text documents. On the basis of this vector, a term document matrix (TDM) can be generated. The TDM can comprise each of the n documents and/or patents as a row vector that represents the weights of the term vector T in the following form:

$$TDM = ( \begin{matrix}{w}_{11} & … & {w}_{1 m} \\ ⋮ & ⋱ & ⋮ \\ {w}_{n 1} & … & {w}_{nm}\end{matrix} ) .$$

This means that a document i can be described by a numerical weight vector dᵢ, that can also be called a document vector. The document vector can relate to the weights as follows:

dᵢ=(w₁₁, . . . , w₁ₘ)

The shortened document vector in the Boolean representation can for example look as follows:

dᵢ=(0,0,0,0,0,0,0,0,0,1,1,0,0,1,0,0,0,1,1,0,0,0,0,0,0,0,0,0,0,0)

Since the term vector comprises each term or keyword from all of the documents exactly once, most weight elements wᵢₜ of a document vector have the value zero. This can lead to two problems during implementation of the vector space model. First, the null values take up unnecessary memory, and second, manipulation of the vectors during comparison of text documents leads to unnecessary multiplications by null values. Therefore, it is more advantageous and practical to present the document vector dᵢ as a set of coordinate-weight pairs (cᵢₜ; wᵢₜ). The document vector from the above expression can then be written as:

dᵢ={(10;1), (11,1), (14;1), (18;1), (19;1)}.

The first part of the doublet stands for the coordinate cᵢₜ and describes the position and/or the index in the term vector T. In this representation, the TDM matrix can comprise a doublet as each of its elements wᵢⱼ with and can be considered a tensor.

In this way, each document can be represented as a vector in a vector space. Generally, the term vector for the whole collection or database comprising documents can comprise a million or more components. However, each document can get converted into a document vector with about 100-500 components. That is, the number of keywords per document can be reduced in such a way, that the document vector can comprise about 100-500 keywords.

The vector space method allows to quantify different text documents by associating them to a point and/or a vector within a multi-dimensional vector space based on the keywords present in the text. Then, different text can be compared by computing their proximity within the vector space. This can be for example done using the cosine index CI given below for reference.

$$CI = \frac{{\sum }_{t = 1}^{m} {w}_{it} * {w}_{jt}}{\sqrt{{\sum }_{t = 1}^{m} {w}_{it}^{2} * {\sum }_{t = 1}^{m} {w}_{jt}^{2}}}$$

### BRIEF DESCRIPTION OF THE DRAWINGS

The skilled person will understand that the drawings, described below, are for illustration purposes only. The drawings are not intended to limit the scope of the present teachings in any way.

FIG. 1 shows an embodiment of a device for semantic search according to one aspect of the invention.

FIG. 1b schematically depicts one embodiment of converting a query to text document data.

FIG. 1c schematically depicts one embodiment of visualization of a vector space model.

FIG. 2 depicts an embodiment of a method for semantic search according to one aspect of the invention.

### DESCRIPTION OF VARIOUS EMBODIMENTS

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps can be present between some or all of the described steps.

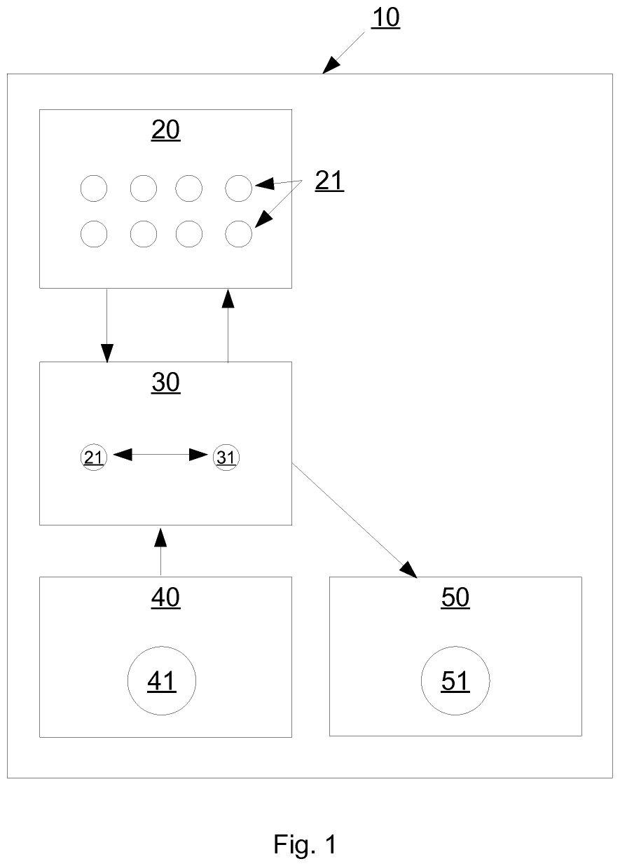

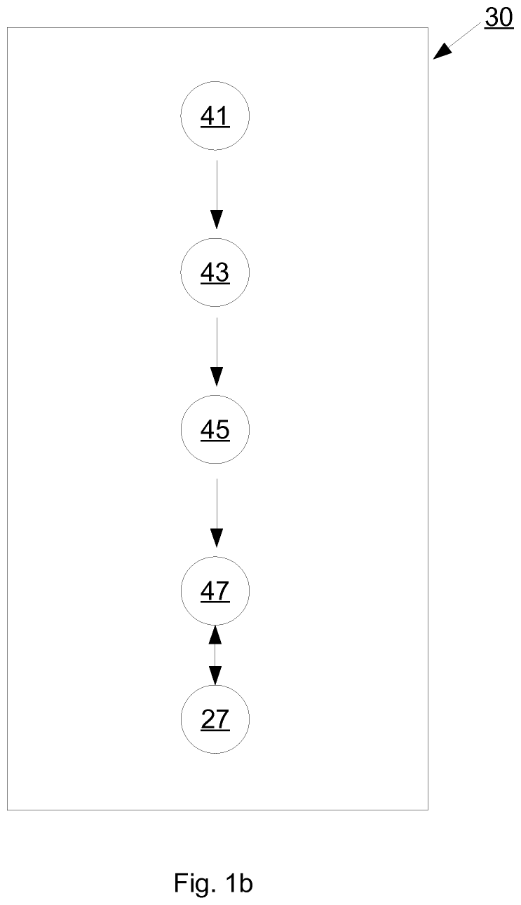

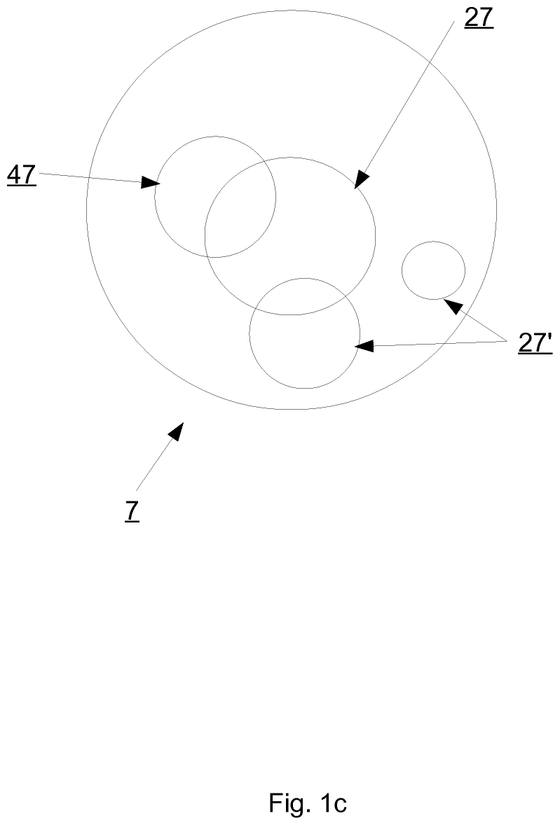

Referring to FIG. 1, an example of a setup of the present invention is shown. The figure depicts a computer-implemented system 10 according to one aspect of the invention.

The computer-implemented system 10 comprises a memory component 20. The memory component 20 can comprise a standard computer memory such as RAM. Additionally or alternatively, the memory component 20 can comprise a non-volatile memory component such as a hard drive, storage on a server, flash memory, optical drives, FeRAM, CBRAM, PRAM, SONOS, RRAM, racetrack memory, NRAM, 3D XPoint, and/or millipede memory.

The memory component 20 can comprise first text document data 21. First text document data 21 can comprise document vectors. Document vectors can be built from text documents. That is, each text document can be mapped to a document vector by identifying the keywords within the document. One document vector can comprise 100-500 components (that is, dimensions) comprising individual keywords.

The computer-implemented system 10 can also comprise a processing component 30. The processing component 30 can be adapted to receive second text document data 31 and compare it with first document data 21. Second text document data 31 can also comprise document vectors. For example, it can comprise a user-defined query, and/or a user given identification of a text document (such as a patent number for example). Second text document data 31 can comprise a document vector that is already part of first text document data 21. For example, a user interface can be used to search for patents and/or patent applications that are similar to a particular patent and/or patent application, that is already part of the database within the computer-implemented system 10 (that is, already part of first text document data 21 within the memory component 20).

The processing component 30 can be adapted to receive a query 41 from an input device 40. That is, the query 41 can be, for example, typed in via a user interface into an app, a program and/or a browser-based interface, that would, in this case, serve as the input device 40. The query 41 can comprise a text and/or a certain identification of a second text document (as mentioned above, this can comprise the patent and/or patent application number for example). Having received the query 41, the processing component 30 can convert it into second text document data 31 by, for example, identifying all of the keywords within the query, removing stop words, performing stemming and generating a document vector for the query. As mentioned above, if the query identifies a document that is already part of the database (of first text document data 21) within the memory component 20, the processing component 30 can simply retrieve the document vector associated with second text document data 31. The processing component 30 can then compare the second text document data 31 to all of the first text document data within the memory component 20. It can identify the most similar documents (identified with their respective document vectors), preferably based on the distance between the document vectors within a multi-dimensional vector space.

Having identified the most similar documents within the first text document data 21, the processing component can send the result to an output device 50. The output device 50 can then output at least one similar first text document 51 that is associated with first text document data 21 that is the most similar to the query 41. Of course, the output device 50 can output a plurality of similar first text documents 51 ordered based on their similarity to the query 41. The output device 50 can comprise, for example, via an interface such as a program, an app and/or a browser-based interface accessible via a computing device.

FIG. 1b schematically depicts one embodiment of converting a query 41 to text document data. The process can take place within a processing component 30, which can comprise, for example, a CPU associated with a computing device. Additionally or alternatively, the processing component can comprise multiple CPUs and/or a CPU with multiple kernels, for example for parallel processing. The query 41 can be transferred to the processing component 30 from an input device 40 (not shown here). The query 41 can first be harmonized to obtain a harmonized query 43. The process of harmonizing is described above. The harmonized query 43 can then be normalized to obtain a normalized harmonized query 45. The process of normalizing is also described above in more detail.

The normalized harmonized query 45 (respectively, the harmonized normalized query 43) can then be converted to a query vector 47. The query vector 47 can be generated by associating the keywords or “terms” of the normalized harmonized query 45 to components or dimensions in a multidimensional vector space. The query vector 47 can then be compared to the document vectors 27 that can be stored within the memory component 20 (not shown here).

Note, that document vectors 27 can refer in the present document to first text document data 21. The term “document vectors” can be used for clarity, so that the skilled reader understands that a plurality of distinct document vectors is referred to. The comparison between the query vector 47 and the document vectors 27 can be done, for example, on the basis on the distance in the multidimensional vector space. Of course, for such a comparison, both the query vector 47 and the document vectors 27 should lie in the same vector space, that is, the space defined by the same dimensions. To achieve this, the database comprised within the memory component 20 (not shown) can comprise a term vector. The term vector can comprise one component or one dimension for each term or keyword present in all of the first text documents stored within the database. The query vector 47, as well as the document vectors 27 can then indicate the keywords or terms present in the query 41, respectively in the specific document, with respect to the dimensions or components of the term vector. In this way, a unique and consistent vector space can be generated. This is explained in more detail above.

FIG. 1c schematically depicts one embodiment of a visualization of a vector space model. Note, that this graphic illustration is for the purposes of clarification only, and does not correspond to the mathematical description of the vector space model. A term vector 7 is shown schematically as a circle. The term vector 7 can comprise a plurality of keywords or terms. These keywords or terms can be extracted from a plurality of text documents. In preferred embodiments, the term vector 7 comprises all of the keywords from all of the text documents comprised within a database (that is, all of the keywords from first text documents). This is represented in the figure by a large circle. The query vector 47 can be generated from the keywords within the query 41 (not shown here). Note, that in the present schematic illustration, the query vector 47 is fully contained within the term vector 7, implying that all of the keywords that the query 41 comprises are contained within the first text documents comprised in a database and from which the term vector 7 is generated. This, however, need not be the case. It is entirely possible, that the query 41 comprises keywords not contained within the first text documents, and, therefore, the query vector 47 need not lie entirely within the vector space generated by the keywords of the term vector 7. However, if this is the case, the keywords of the query 41 that are not contained within the term vector 7 will result in no similarities with any of the first text documents, and therefore can be disregarded for the purpose of finding the most similar first text documents. Therefore, the query vector 47 can be viewed as generated using only the keywords that are already accounted for in the term vector 7. Note, that also synonyms of keywords can be used for semantic similarity comparisons.

Document vector 27 is depicted as having an intersection with the query vector 47. This refers to them comprising some of the same keywords and/or their synonyms. Therefore, a non-zero similarity measure can be generated between the query vector 47 and the document vector 27. However, document vectors 27′ are depicted as having no intersection with the query vector 47. This refers to the query 41 and the text documents associated with document vectors 27′ not sharing any keywords or their synonyms. This can mean, that the query vector 47 and document vectors 27′ can be assigned a null similarity measure.

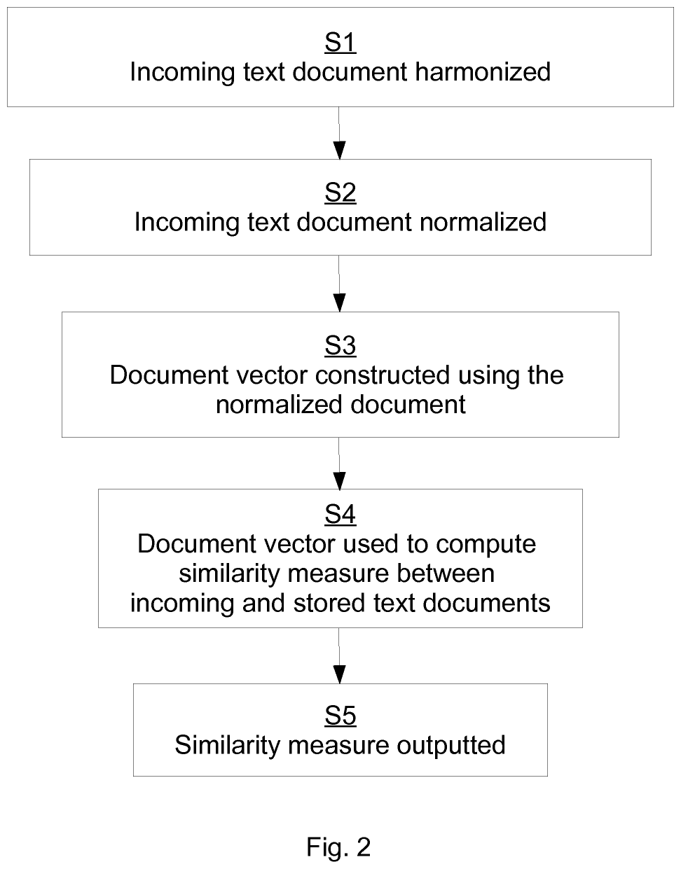

FIG. 2 schematically shows an embodiment of the method for semantic processing of similarities in text documents according to one aspect of the invention. The figure shows a flowchart describing the steps of comparing an incoming document to an existing pool or database of stored documents.

As an example scenario, consider a user who has a certain text that can for example be a patent and/or a patent application. The user requires a so-called “prior art search”. That is, the user needs to acquire or find other patent documents that are close in content to the text they have. The user can then use the invention in the following way. They can send or upload the text document in question to the system. This can, for example, be done via an interface. In one embodiment, the system as described herein can comprise an app-based or browser-based interface for receiving queries. The user can then use the interface to send the query to the system, at which point the following steps can occur.

In S1, an incoming text document or query can be harmonized. That is, typographical errors can be corrected. Further, spelling can be normalized. For example, one convention can be chosen from the British and American spelling conventions, and all words differing in the two conventions can be converted to the chosen one. That is, words such as “colour”, “theatre” can be converted to “color” and “theater” or vice versa. Furthermore, harmonizing can comprise converting different physical units to one standard one, and/or to one particular one. For example, inches can be converted to meters, pounds to kilograms and so on. Furthermore, harmonizing can comprise converting formulas such as chemical formulas, gene sequences and/or protein representations to a standard notation.

In S2, the incoming text document can be normalized. This can comprise isolating stop words contained in the text of the document and removing them. Stop words can comprise words such as “and”, “first”, “however”. Stop words can also be specific to the type of text document being analysed. For example, patent literature comprises words such as “claim”, “embodiment”, “device” that are present in most patent text documents. These words can similarly be identified and removed during the normalizing step. Further, normalizing can comprise reducing words to their stems. That is, words such as “computer” and “computing” can for example be reduced to their common stem. Then, the stems can be analysed for synonyms. Furthermore, word sequences and compound words can be identified during the normalizing step. That is, words such as “paper-clip” can be identified, and not separated for the purpose of stemming, in order to keep the meaning of the compound word together.

In S3, a document vector can be constructed using the text document that can first be harmonized and/or normalized. The document vector can be a multidimensional vector comprising information on which “terms”, that is, word stems and their synonyms are contained in the text document. This is further explained above. Note, that the document vector can also comprise a tensor in some embodiments.

In S4, the generated document vector can be used to compute a similarity measure between the incoming text document and stored text documents. That is, the incoming text document, or rather its document vector can be compared to a database comprising text documents previously converted to document vectors. Note, that in order to have a common baseline for comparison between different document vectors, there can be one “term vector” comprising all of the “terms” (that is, words and/or stems and/or synonyms) contained in all of the text documents within the database.

The individual document vectors can then simply indicate which of the terms comprised in the term vector are present in the given document. The term vector can then define a multidimensional vector space, in which each term can comprise a dimension. Each of the document vectors can be represented or visualized as a dot or vector in this multidimensional vector space. To compare the document vector generated from the incoming text document with each of the document vectors comprised in the database, the distance between them can be calculated. Note, that calculating distance between vectors in a vector space can be one way or one part of obtaining the similarity measure between the incoming document and the stored text documents. However, there can also be other ways to do this based on lexical and/or semantic analyses. Furthermore, there can also be further variables comprised in the similarity measure. For example, weighting of the keywords based on the frequency with which they appear in the document and/or based on the technical area of the document can then be integrated into the document vector and therefore play a role in the similarity measure. Further, bibliographic variables of the text documents can be used. In the specific example of patent literature, these can comprise IPC classes, CPC classes, Applicant, Inventor, Patent Attorney, Citations, References, co-citations and co-references information, image information.

In S5, the similarity measure can be outputted. For example, several text documents can be outputted, ranked by the similarity measure to the original inputted text document or query. Going back to the example given above of an interface within an app and/or a browser, the similarity measure can be outputted via the same interface. That is, a list of text documents similar to the incoming text document or the query can be shown via the app and/or browser ordered in a certain way, such as starting from most similar document for example. Note, that “outputting similarity measure” can refer herein to outputting at least one or a plurality of documents that have been determined to be the most similar to the query.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. A computer-implemented method for comparing text documents comprising the steps of
a) building a database comprising first text document data (21) associated with a plurality of first text documents; and
b) receiving a query (41); and
c) converting the query (41) to second text document data (31); and
d) comparing second text document data (31) to first text document data (21) and computing at least one similarity measure between second text document data (31) and first document data (21).

2. A method according to claim 1 wherein first text document data (21) comprises document vectors (27) generated from keywords comprised in first text documents and/or from words semantically related to said keywords.

3. A method according to claim 1 wherein the query (41) comprises a second text document and/or information identifying a second text document associated with second text document data (31) comprised within the first text document data (21) already stored within the memory component (20).

4. A method according to claim 1 wherein converting the query (41) to second text document data (31) comprises harmonizing the query (41).

5. A method according to claim 1 wherein converting the query to second text document data (31) comprises normalizing the query (41).

6. A method according to claim 5 wherein normalizing the query (41) comprises retrieving at least synonyms, hypernyms, hyponyms, stop words and/or subject specific stop words from an external database and generating a list of the query's (41) keywords based at least partially based on said retrieved words.

7. A method according to claim 6 wherein the list of the query's (41) keywords is generated by removing stop words and/or subject-specific stop words and including at least one of the synonyms, hypernyms and hyponyms of the query's words.

8. A method according to claim 1 wherein converting the query (41) to second text document data (31) comprises generating at least one query vector (47).

9. A method according to claim 8 wherein the query vector (47) is generated by identifying keywords and/or synonyms of keywords from the query (41) and identifying said keywords with components of a vector in a multidimensional vector space.

10. A method according to claim 9 wherein the query vector (47) comprises from 100 to 500 components, preferably from 200 to 400 components, even more preferably from 200 to 300 components.

11. A method according to claim 1 wherein converting the query (41) to second text document data (31) comprises generating at least one query vector (47) and the query vector (47) is generated by identifying keywords and/or synonyms of keywords from the query (41) and identifying said keywords with components of a vector in a multidimensional vector space, wherein the keywords are assigned a weight.

12. A method according to claim 11 wherein weights are assigned at least partially based on the general subject of the query (41).

13. A method according to claim 1 wherein computing the similarity measure comprises applying at least one or a combination of the Cosine Index, Jaccard Index, Dice Index, Inclusion Index, Person Correlation Coefficient, Levenstein Distance, Jaro-Winkler Distance and/or Needleman-Wunsch Algorithm.

14. A method according to claim 1 further comprising after step d) steps
f) validating the at least one similarity measure using at least one statistical algorithm; and
g) outputting the at least one similarity measure.

15. A method according to claim 14 wherein the query (41) is received from a user interface and the similarity measure is returned via said interface,

16. A method according to claim 7 wherein the database comprises patent literature-related text documents and wherein building the database and/or converting the query (41) comprises removing stop words associated with patent literature-related text documents.

17. A method according to claim 16 wherein patent-related stop words are removed by computing the entropy associated with terms comprised in first text document data (21) and/or in the query (41) and removing terms with low entropy.

18. A method according to claim 1 further comprising generating a term vector (7) comprising keywords extracted from the plurality of first text documents.

19. A method according to claim 18 and with features of claims 2 and 8 wherein the components of the document vectors (27) and the query vector (47) are generated with respect to the components of the term vector (7).

20. A method according to claim 1 wherein first text document data (21) comprises document vectors (27) generated from keywords comprised in first text documents or from words semantically related to said keywords, wherein converting the query (41) to second text document data (31) comprises generating at least one query vector (47), and wherein the similarity measure between second text document data (31) and first document data (21) is computed by using the cosine index to compute the distance between the query vector (47) and the document vectors (27).

21. A computer-implemented method for processing of similarities in text documents comprising
a) harmonizing at least one incoming query (41); and
b) normalizing the at least one incoming harmonized query (43); and
c) constructing at least one query vector (47) using the at least one normalized harmonized query (45); and
d) computing at least one similarity measure between the at least one query vector (47) and at least one further text document, wherein the at least one further text document underwent the previous steps.

22. A method according to claim 21 wherein the text document comprises at least one or a combination of technical text, scientific text, patent text, and/or product description.

23. A method according to claim 21 wherein harmonizing comprises correcting typographical errors, choosing a particular spelling convention and physical unit convention and adjusting the text based on it, and/or representing formulas (for example chemical formulas, gene sequences and/or protein representations) in a standard way.

24. A method according to claim 21 wherein normalizing comprises identifying and removing stop words, reducing words to common word stems, analysing the stems for synonyms and/or identifying word sequences and compound words.

25. A method according to claim 24 wherein normalizing further comprises identifying and removing stop words associated with a certain type of text documents, preferably by computing the entropy of terms within a plurality of text documents of said type and removing words with low entropy.

26. A method according to claim 21 wherein computing the similarity measure comprises applying at least one or a combination of the Cosine Index, Jaccard Index, Dice Index, Inclusion Index, Person Correlation Coefficient, Levenstein Distance, Jaro-Winkler Distance and/or Needleman-Wunsch Algorithm.

27. A method according to claim 21 further comprising, after step d), the following steps:
f) validating the at least one similarity measure using at least one statistical algorithm; and
g) outputting the at least one similarity measure.

28. A computer-implemented system (10) according to claim 21 comprising
a) at least one memory component (20) adapted for at least storing a database comprising a plurality of first text document data (21) associated with first text documents;
b) at least one input device (40) adapted for receiving a query (41), said query (41) comprising a second text document and/or information identifying a second text document, said second text document associated with second text document data (31) comprised within first text document data (21) already stored within the memory component (20); and
c) at least one processing component (30) adapted for converting a query (41) into second text document data (31) and/or retrieving second text document data (31) associated with the query (41) from storage within the at least one memory component (20) and comparing second text document data (31) to the first text document data (21) stored within the at least one memory component (20);
d) at least one output device (50) adapted for returning information identifying at least one similar first text document (51) associated with first text document data (21), said similar first text document (51) most similar among first text documents to the query (41).

29. A system according to claim 28 wherein the first text document data (21) comprises a plurality of document vectors (27) and wherein the second text document data (31) comprises a query vector (47).

30. A system according to claim 28 wherein the memory component (20) comprises first text document data (21) associated with scientific articles and/or technological descriptions and/or patent literature and or product description.

31. A system according to claim 28 wherein second text document data (31) is obtained by harmonizing and normalizing the second text document and constructing at least one query vector (47).

32. A system according to claim 28 wherein the comparison between first text document data (21) and second text document data (31) yields a similarity index.

33. A system according to claim 32 wherein the output device (50) returns information associated with a plurality of first text documents ordered by the similarity index from most similar to least similar, said first text documents associated with first text document data (21) yielding the highest similarity index with second text document data (31).

34. A system according to claim 28, wherein the similarity index is based on lexical and/or semantic comparison between text documents.

35. A system according to claim 28 wherein the processing component (30) identifies keywords during harmonizing and normalizing of the incoming second text document.

36. A system according to claim 28 wherein the processing component (30) assigns weight to keywords based on an entropy algorithm.

37. A system according to claim 28 wherein the processing component (30) is adapted to divide the second text document into at least two parts for parallelized computing, preferably into at least four parts.

38. A system according to claim 37 wherein the processing component (30) comprises at least two, preferably at least four, more preferably at least eight kernels.

39. A system according to claim 28 wherein the processing component (30) is adapted to update first document data (21) stored within the memory component (20) regularly.

40. A system according to claim 28 wherein the input device (40) is further adapted to permit specifying the query (41) by listing words and/or sentences that similar text documents must comprise and/or must not comprise.

41. A system according to claim 28 wherein the input device (40) is further adapted to permit specifying the query (41) by specifying the number of most similar text documents to be outputted.

42. A system according to claim 28any of the preceding claims 28. wherein the memory component (20) comprises RAM (random-access memory).

43. A system according to claim 28 wherein the memory component (20) further comprises a term vector (7) comprising keywords extracted from the plurality of first text documents.

44. A system according to claim 43 and with features of claim 29 wherein the processing component (30) is adapted to generate the components of the document vectors (27) and the query vector (47) with respect to the components of the term vector (7).

45. A system according to claim 28 and with features of claim 29 wherein the processing component (30) is adapted to compare the second text document data (31) to the first text document data (21) by using the cosine index to compute the distance between the query vector (47) and the document vectors (27).
